(19) United States
(12) Patent Application Publication
(10) Pub. No.: US 2015/0151568 A1
(43) Pub. Date: Jun. 4, 2015

(54) COLLAPSIBLE THREE-DIMENSIONAL WALL ARTWORK

(71) Applicant: BUYSEASONS, Inc., New Berlin, WI (US)

(72) Inventor: Shane Douglas Smith, Snohomish, WA (US)

(73) Assignee: BUYSEASONS, Inc., New Berlin, WI (US)

(21) Appl. No.: 14/094,496

(22) Filed: Dec. 2, 2013

(51) Int. Cl. B44F 7/00; B65H 45/12

(52) U.S. Cl. CPC B44F 7/00; B65H 45/12

(57) ABSTRACT

Three-dimensional wall artwork and methods of producing the same are provided. One collapsible three-dimensional wall artwork includes a collapsible protruding member. The collapsible protruding member includes at least one folding portion and a connecting portion configured to couple the collapsible protruding member to a wall. The at least one folding portion is configured to be folded to form a three-dimensional structure extending outward from the wall in an assembled configuration.

### BACKGROUND

The present disclosure generally relates to decorative accessories, and more particularly to a three-dimensional artwork.

Wall decorations are popular in residential and commercial environments. For example, wall artwork may be hung in a bedroom or provided in a space where a party or gathering is being held. Typical wall artwork or decorations may be two-dimensional (e.g., a poster taped to a wall).

### SUMMARY

One embodiment of the present disclosure relates to a collapsible three-dimensional wall artwork. The collapsible three-dimensional wall artwork includes a collapsible protruding member. The collapsible protruding member includes at least one folding portion. The collapsible protruding member further includes a connecting portion configured to couple the collapsible protruding member to a wall. The at least one folding portion is configured to be folded to form a three-dimensional structure extending outward from the wall in an assembled configuration.

Another exemplary embodiment relates to a kit for forming a three-dimensional wall artwork. The kit includes one or more pieces having a substantially flat state in a disassembled configuration. The one or more pieces include a connecting portion configured to couple to the one or more pieces to a wall. The one or more pieces are configured to be attached in an assembled configuration to form a three-dimensional structure extending outward from the wall.

Another exemplary embodiment relates to a method of producing a collapsible three-dimensional wall artwork. The method includes forming a collapsible protruding member. The method further includes forming a plurality of foldable creases in the collapsible protruding member. The method further includes forming a plurality of folding connection portions in the collapsible protruding member. The method further includes forming a wall connection portion in the collapsible protruding member. The collapsible protruding member is configured to be folded at the foldable creases and the plurality of folding connection portions are configured to be connected to one another such that the collapsible protruding member forms a three-dimensional structure extending outward from a wall in an assembled configuration. The connection portion is configured to couple the collapsible protruding member to the wall.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a three-dimensional wall artwork in a fully formed state, according to an exemplary embodiment;

FIG. 2A is a flow chart of a process for producing a three-dimensional wall artwork, according to an exemplary embodiment;

FIG. 2B is a flow chart of a process for forming the three-dimensional wall artwork of FIG. 1, according to an exemplary embodiment;

FIGS. 3-6 illustrate the assembly of the three-dimensional wall artwork of FIG. 1 as described in the process of FIG. 2B, according to an exemplary embodiment;

FIGS. 7-8 illustrate the process of coupling the three-dimensional wall artwork of FIGS. 3-6 to a wall, according to an exemplary embodiment; and

FIGS. 9-11 are perspective views of further examples of three-dimensional wall artwork, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a collapsible three-dimensional wall artwork is shown and described. The wall artwork may generally include a collapsible protruding member, which is flat in a disassembled configuration. A user may form the wall artwork by folding and/or combining at least one folding portion of the collapsible protruding member to form the three-dimensional shape of the wall artwork. The user may then use a connecting portion of the collapsible protruding member to couple the wall artwork to a wall. When the wall artwork is not assembled or in use, the wall artwork may be flat and stored or packaged.

The various portions of the collapsible protruding member may include various tabs and slots. The three-dimension shape of the wall artwork may be formed by folding the folding portions of the collapsible protruding member and inserting a plurality of tabs into a plurality of slots.

The collapsible protruding member may include any number of folding portions. In one embodiment, the collapsible protruding member may consist of a single folding portion that may be folded into a three-dimensional shape. In another embodiment, the collapsible protruding member may consist of two or more portions that are not foldable, but form a three-dimensional shape when assembled together. In another embodiment, the collapsible protruding member may consist of two or more foldable portions and non-foldable portions which may form a three-dimensional shape when assembled together. It should be understood that any combination of folding portions may be included as part of the collapsible protruding member. The shapes formed by the folding of the various portions may be substantially spherical, rectangular, cylindrical or any other type of three-dimensional shape.

In one embodiment, the wall artwork may further include a base member. The base member may be a substantially flat portion of the wall artwork configured to be coupled to a wall. The base member may couple to the wall in various ways (via nails, clips, or other attachable members, via an adhesive on the back of the base member, etc.). The connecting portion of the collapsible protruding member may couple to the base member. In one embodiment, clips or other supporting members may be attached to the base member to allow the base member to support the connecting portion of the collapsible protruding member. In other embodiments, the connecting portion of the collapsible protruding member may couple directly to the wall or to a supporting member (e.g., clip, nail, adhesive) of the wall. The connecting member may include various slots for coupling to the base member and/or wall.

In one embodiment, the wall artwork and, more particularly, the collapsible protruding member may be formed of cardboard. In other embodiments, the wall artwork and components thereof may additionally or alternatively be formed of other materials, such as plastic, metal, etc. For example, the base member of the wall artwork may be made of any material configured to be attachable to a wall.

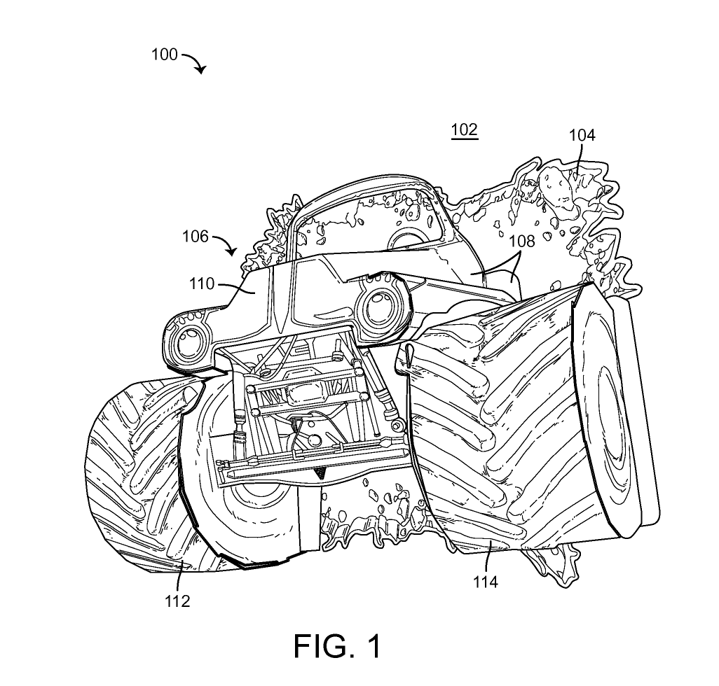

Referring now to FIG. 1, a perspective view of an example wall artwork 100 is shown, according to an exemplary embodiment. The wall artwork 100 is shown fully formed in an assembled or use configuration. The wall artwork 100 is shown mounted on a wall 102. The wall artwork 100 may generally include a base 104 and a collapsible portion 106. The base 104 is coupled to the wall 102. The base 104 may be coupled to the wall 102 in a variety of methods (e.g., via an adhesive, via one or more clips, nails, or other attachable members coupled to the wall 102, etc.). The base 104 may include any graphic or design to blend with the wall 102, to match the graphics or design of the collapsible portion 106.

The collapsible portion 106 may be configured to be flat in a disassembled state and three-dimensional in an assembled state. The collapsible portion 106 may generally include multiple folding portions and connecting portions. For example, in the embodiment of FIG. 1, the collapsible portion 106 includes a connection portion 108. The connection portion 108 couples to the base portion 104, thereby mounting the wall artwork 100 on the wall 100. In one embodiment, the connection portion 108 may include slots into which a tab, clip, or other member of or attached to the base 104 may be inserted. In another embodiment, the connection portion 108 may include tabs, clips, or other attachable members to couple to the base 104 and wall 102.

In the illustrated exemplary embodiment, the collapsible portion 106 further includes multiple folding portions 110, 112, 114. The folding portions 110, 112, 114, in a use configuration, form the three-dimensional shape of the wall artwork 100. The folding portions 110, 112, 114 may be substantially flat in a disassembled state. The folding portions 110, 112, 114 are configured to be folded and inserted into slots of the connecting portion 108 and the other folding portions.

In the embodiment of FIG. 1, the example wall artwork 100 is a vehicle, more particularly a monster truck. The monster truck generally includes a front portion 110, a right tire portion 112, and a left tire portion 114 which form the three-dimensional shape of the wall artwork 100. The collapsible portion 106 is shown to include artwork that represents a truck cab portion of the monster truck.

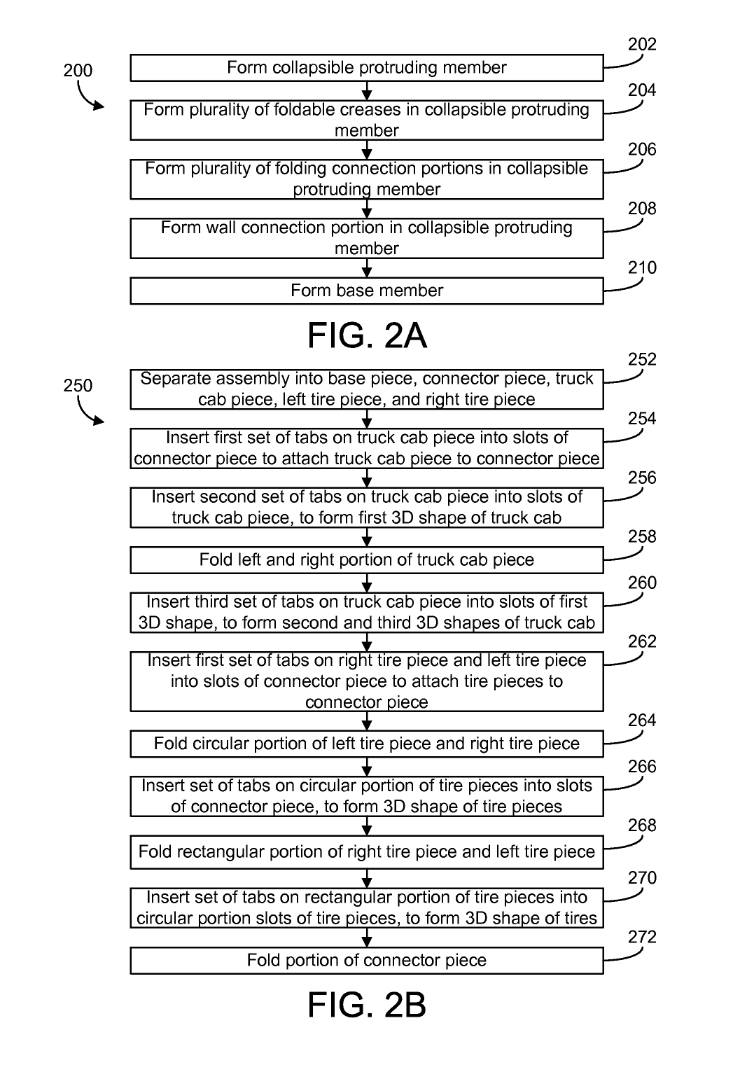

While the monster truck shown in FIG. 1 and in subsequent figures is provided as an example wall artwork, it should be understood that any type of three-dimensional wall artwork may be formed using the methods described in the present disclosure. For example, a process of forming the three-dimensional monster truck is provided in FIG. 2B; however, the process may be adapted to form any three-dimensional object. The three-dimensional wall artwork may be of any shape or size, and may include any type of graphic or design imprinted on the wall artwork.

Referring now to FIG. 2A, a flow chart of a process 200 for producing a three-dimensional wall artwork is shown, according to an exemplary embodiment. The process 200 may be executed to form any three-dimensional wall artwork such as, for example, the monster truck of FIG. 1.

The process 200 includes forming a collapsible protruding member (step 202). The collapsible protruding member may generally include one or more portions for coupling the collapsible protruding member to a wall (e.g., via a base piece or directly to the wall) and one or more folding portions (described in step 206). The various portions are flat in a disassembled state. The collapsible protruding member may be of any shape or design for forming a three-dimensional shape. The collapsible protruding member may be a single piece or more than one independent pieces to be coupled together. The collapsible protruding member may be formed from cardboard or another material.

The process 200 includes forming a plurality of foldable creases in the collapsible protruding member (step 204). The collapsible protruding member is configured to be folded at the foldable creases. The folding of the foldable creases allows for the formation of the three-dimensional shape of the collapsible protruding member. In one embodiment, the foldable creases may be formed in the various folding portions of the collapsible protruding member. In another embodiment, the foldable creases may also be formed in the connection portions of the collapsible protruding member. In some embodiments, rather than or in addition to foldable creases, the three-dimensional shape may be formed using one or more non-foldable collapsible protruding members as well.

The foldable creases may be configured to cause the wall artwork to have varying shapes and features. For example, a foldable crease may be relatively small, allowing for a sharp edge of the three-dimensional shape to be formed. As another example, the foldable creases may be relatively large and curved, allowing for a more curved shape of the three-dimensional shape, such as the tires of the vehicle shown in FIG. 1. As another example, many foldable creases may be included to help form a round shape of the three-dimensional shape, or a single foldable crease may be included to help form a sharp edge or rectangular shape of the three-dimensional shape.

The process 200 includes forming a plurality of folding connection portions in the collapsible protruding member (step 206). The folding connection portions may be part of the foldable portions (e.g., via the foldable creases of step 204) configured to be connected to each other to form part or all of the three-dimensional shape of the collapsible protruding member.

In one embodiment, the folding connection portions (and the connecting portions) may include a plurality of slots and tabs. The tabs are configured to be inserted into the slots to secure the assembly of the three-dimensional shape.

The process 200 includes forming a wall connection portion in the collapsible protruding member (step 208). The wall connection portion is configured to couple the collapsible protruding member to the wall. The wall connection portion, in various embodiments, may include a plurality of slots configured for insertion of a tab, and/or a plurality of tabs to insert in a slot coupled to the wall. The wall connection portion may or may not include foldable creases and/or folding connection portions as formed in steps 204, 206.

The process 200 may optionally include forming a base member of the three-dimensional wall artwork (step 210). The base member may be a substantially flat portion of the wall artwork configured to be coupled to the wall. The base member may be coupled to the wall via an adhesive such as tape or glue, or by nails, tacks, hooks, or any other type of fastening material. In some embodiments, the base member may have a coating of adhesive pre-applied to a back portion of the base member during manufacturing of the base member.

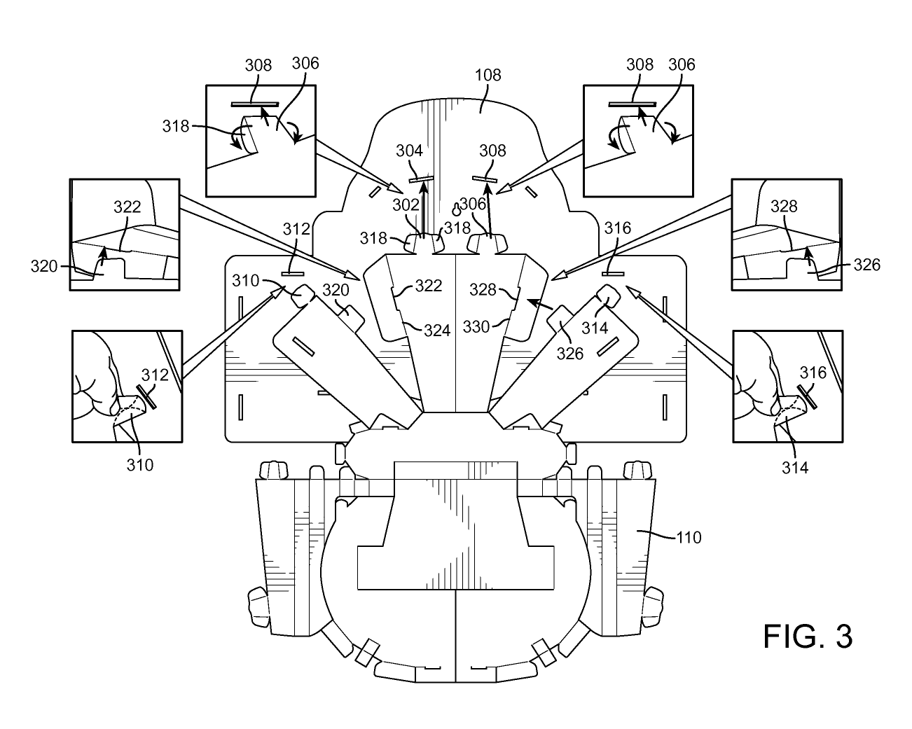

Referring now to FIG. 2B, a flow chart of a process 250 for forming the three-dimensional wall artwork of FIG. 1 is shown, according to an exemplary embodiment. The process 250 is described for forming the monster truck shown in FIG. 1; the process 250 may be adapted to form any type of three-dimensional wall artwork. Referring also to FIGS. 3-6, the assembly of the monster truck of FIG. 1 is illustrated based on the process 250 of FIG. 2B.

The process 250 includes separating the assembly of the wall artwork into its base piece 104, connector piece 108, front piece 110, right tire piece 112, and left tire piece 114 (step 252). The various pieces may be in a substantially flat state in a disassembled state. The wall artwork may be placed in the flat configuration, for example, during packaging for storage in a distribution center, during shipping to a retail location or customer, during display at a retail location, during disassembly for storage by a customer, or during other situations. The flat configuration of the wall artwork allows for the transportation of the wall artwork in a manner that is less likely to result in the wall artwork being damaged than in its use configuration of FIG. 1. The flat configuration also generally takes up less space (e.g., in storage, on a retail display, etc.) than the assembled configuration. Referring also to FIG. 3, a flat configuration of connector piece 108 and front piece 110 is shown in greater detail.

The process 250 includes inserting a first set of tabs of the front piece 110 into slots of the connector piece 108 (step 254). This attaches the front piece 110 to the connector piece 108. As shown in FIG. 3, step 254 includes inserting a tab 302 into slot 304, tab 306 into slot 308, tab 310 into slot 312, and tab 314 into slot 316. When the tabs are inserted, the foldable edges of each tab (shown as edges 318 in FIG. 3 may be folded to fit the tab in the slot. Unfolding the foldable edges 318 after insertion secures the front piece 110 to the connector piece 108.

It should be understood that each tab as described in the embodiments of FIGS. 3-6 and the present disclosure may include foldable edges or other portions to secure the connection between the slots and tabs. Further, the foldable edges may be located anywhere on the tab so long as the folding of the edges secures the connection.

The process 250 includes inserting a second set of tabs of the front piece 110 into slots of the front piece 110 (step 256). This forms a first three-dimensional shape of the monster truck. As shown in FIG. 3, step 256 includes inserting a tab 320 into a slot 322 and a tab 326 into a slot 328. The slots 322, 328 are located on foldable creases 324, 330 of the front piece 110. Before inserting the tabs 320, 326 into the slots 322, 328, the foldable creases 324, 330 may be folded to allow insertion of the tabs. The folding of the crease and the subsequent insertion of the tabs create the three-dimensional shape of the truck cab.

The process 250 includes folding a left and right portion of the front piece 110 (step 258). This forms additional three-dimensional shapes of the monster truck. The three-dimensional shape formed in step 258 may differ from the three-dimensional shape formed in step 256 as the shape is formed using just the front piece 110 instead of the front piece 110 and a second piece.

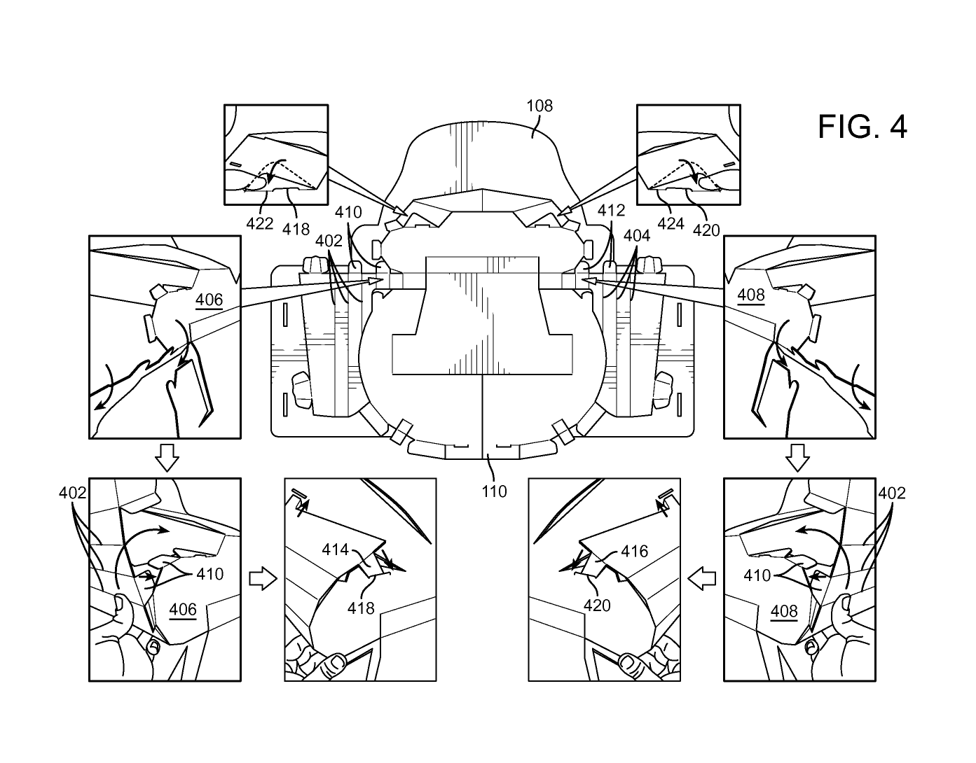

Referring also to FIG. 4, another flat configuration of the connector piece 108 and front piece 110 is shown. As shown in FIG. 4, the front piece 110 is shown to have a plurality of folding creases 402, 404. By folding each of the folding creases 402, 404, additional three-dimensional shapes 406, 408 of the monster truck are formed.

After folding the creases 402, 404, the three-dimensional shape of the front piece 110 may be secured by the use of tabs 410, 412 located on the edge of the front piece. By folding the tabs 410, 412 after folding the creases, the interlocking of the tabs 410, 412 secure the position of the front piece 110.

The process 250 includes inserting a third set of tabs on the front piece 110 into slots of the front piece 110, to form a second and third three-dimensional shape of the monster truck (step 260). The step 260 may be executed to secure the assembly of the three-dimensional shapes formed in step 258.

As shown in FIG. 4, the tabs 414, 416 may be inserted into the slots 418, 420, as shown. Before securing the tabs 414, 416 in the slots 418, 420, edges of the front piece 110 next to the slots 418, 420 may be folded via the foldable creases 422, 424.

In total, the steps 254-260 may be executed to couple the front piece 110 to the connector piece 108 and to form an assembled configuration of the front portion of the monster truck. Steps 254-260 represent three different methods of assembly of the front portion. Step 254 may be executed for slots and tabs that do not create a three-dimensional shape. Step 256 may be executed for slots and tabs that create a three-dimensional shape. Steps 258 and 260 may be executed to form a three-dimensional shape in concert with the folding creases.

The process 250 then includes the introduction of additional pieces to the wall artwork assembly. A right tire piece and left tire piece are introduced that are used to form a three-dimensional right tire and left tire of the monster truck. The process 250 includes inserting a first set of tabs on the right tire piece 112 and the left tire piece 114 into slots of the connector piece 108 to attach the pieces 112, 114 to the connector piece 108 (step 262).

Referring to FIG. 4, the assembly of the wall artwork is shown with connector piece 108, front piece 110, and right and left tire pieces 112, 114, which are flat in their disassembled state. The tabs 504, 508 are inserted into slots 502, 506 of the connector piece 108. The tabs 504, 508 may be tabs that are folded in order to be inserted into the slots 502, 506. For example, since the tabs 504, 508 are larger than the slots 502, 506, the tabs are folded for insertion and then unfolded to couple the tire pieces 112, 114 to the connector piece 108.

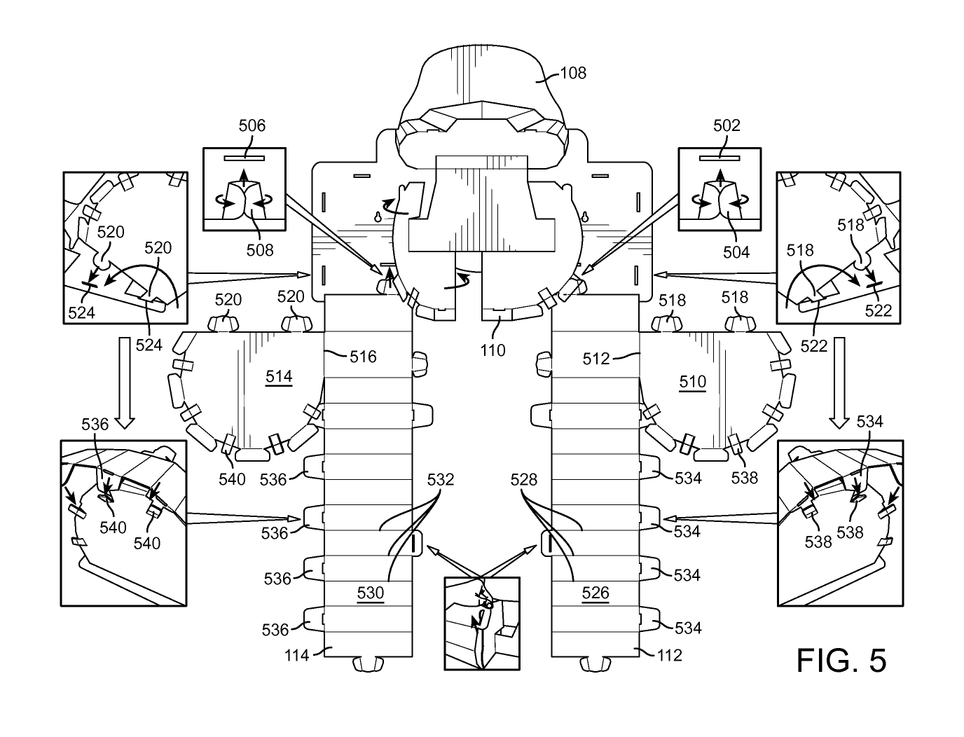

The process 250 includes folding the circular portion of the right tire piece 112 and left tire piece 114 (step 264). Also referring to FIG. 5, the circular portions 510, 514 are folded at an approximately ninety degree, or right, angle using the folding creases 512, 516. The process 250 includes inserting a set of tabs on the circular portion of the right tire piece 112 and left tire piece 114 into slots of the connector piece 108, to form the three-dimensional shape of the tire pieces (step 266).

As shown in FIG. 5, each circular portion 510, 514 includes a pair of tabs 518, 520. The tabs 518, 520 may be inserted into the accompanying slots 522, 524 in the connector piece after the circular portions 510, 514 are folded upwards via the folding creases 512, 516. This provides a second set of tab and slot configurations to secure the tire pieces 112, 114 to the connector piece 108.

The process 250 further includes folding the rectangular portion of the right tire piece 112 and left tire piece 114 (step 268). Also referring to FIG. 5, the folding of the rectangular portions 526, 530 may be accomplished by using the plurality of folding creases 528, 532 in the portions. The use of the plurality of folding creases 528, 532 may be used to create the circular shape of the tires.

The process 250 further includes inserting the set of tabs on the rectangular portion of the tire pieces into the slots of the circular portion of the tire pieces, to form the three-dimensional shape of the tires (step 270). Also referring to FIG. 5, the tabs 534, 536 of the rectangular portions 526, 530 are inserted into the slots 538, 540 of the circular portions 510, 514.

In total, the steps 262-270 may be executed to couple the right tire piece 112 and the left tire piece to the connector piece 108 and to form an assembled configuration of wall artwork. Steps 262-270 represent three different methods of assembly of the tire pieces. Step 262 may be executed for slots and tabs that do not create a three-dimensional shape. Steps 264 and 266 may be executed for slots and tabs that do create the three-dimensional shape. Steps 268 and 270 may be executed for slots and tabs that create a second three-dimensional shape.

It should be understood that the steps shown in FIG. 2B may be reproduced for any number of pieces, slots, and tabs. The process may generally include, for a given piece, inserting a first set of tabs into slots of another piece, forming one or more three-dimensional shapes of the piece, and inserting a second set of tabs into slots of any of the pieces, securing the assembly of the piece.

The process 250 further includes folding a portion of the connector piece 108 to form a notch to attach the connector piece to the base portion 104 (step 272). Step 272 may be executed to allow the wall artwork assembly to be coupled to a wall, may form an additional three-dimensional shape of the wall artwork, or otherwise.

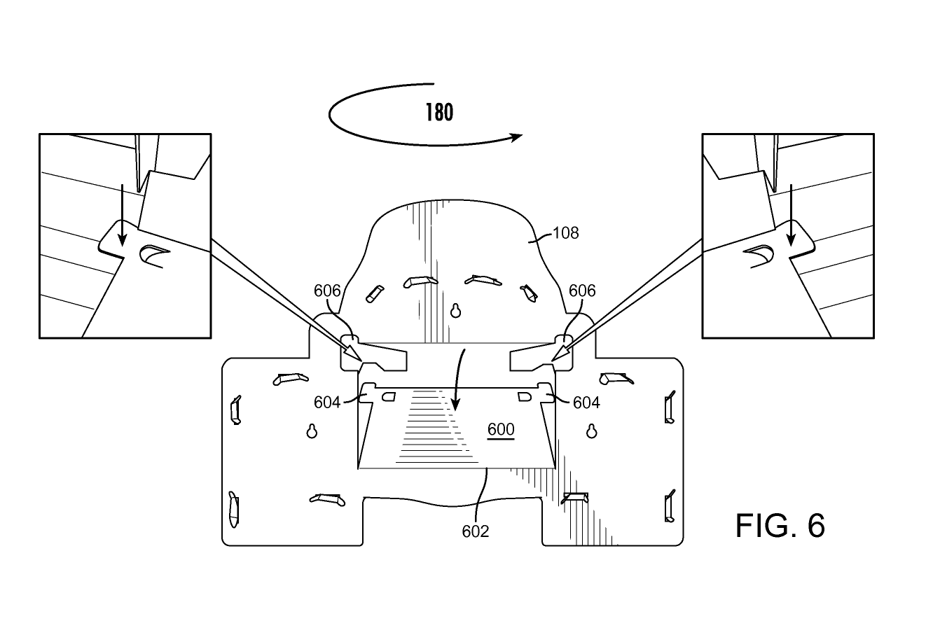

Referring to FIG. 6, a rear view of the assembled wall artwork is shown. A portion 600 of connector piece 108 is folded via folding crease 602. The portion 600 may form a bottom piece of the three-dimensional artwork. The portion 600 may include tabs 604 for forming the shape. The folding of the portion 600 may further create notches 606 that allow the connector piece 108 to couple to other pieces of the wall artwork and/or the base piece 104.

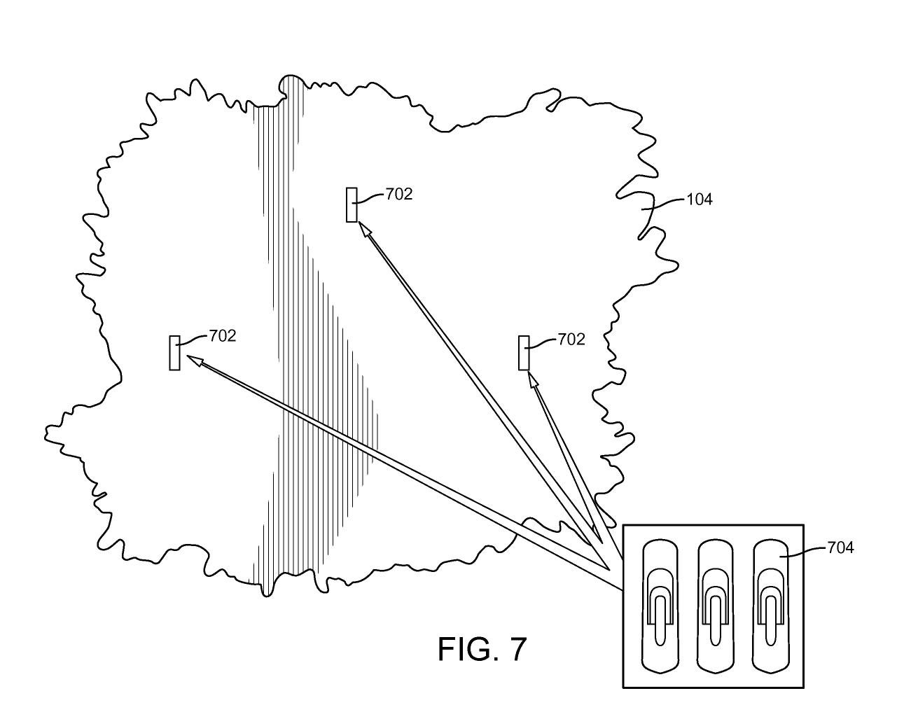

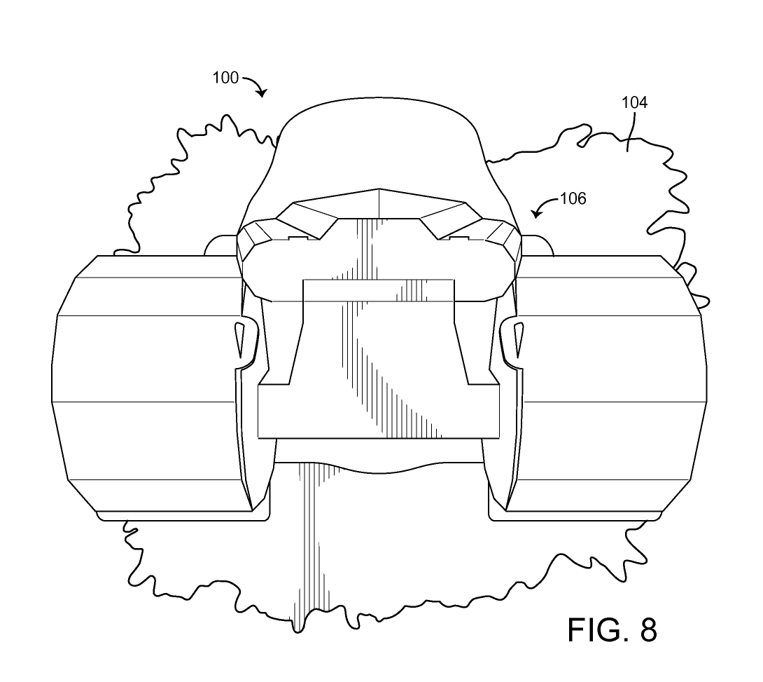

Referring now to FIG. 7, the base piece 104 is shown in greater detail. The base piece 104 is configured to be coupled to the wall. The base piece 104 may include various adhesives 702 for attaching clips 704 to. The clips 704 are configured to couple to slots of the connector piece 108, attaching the wall artwork 100 to the wall. As shown in FIG. 8, the final assembled configuration of the wall artwork 100 is shown, including the base piece 104 and the collapsible portion 106.

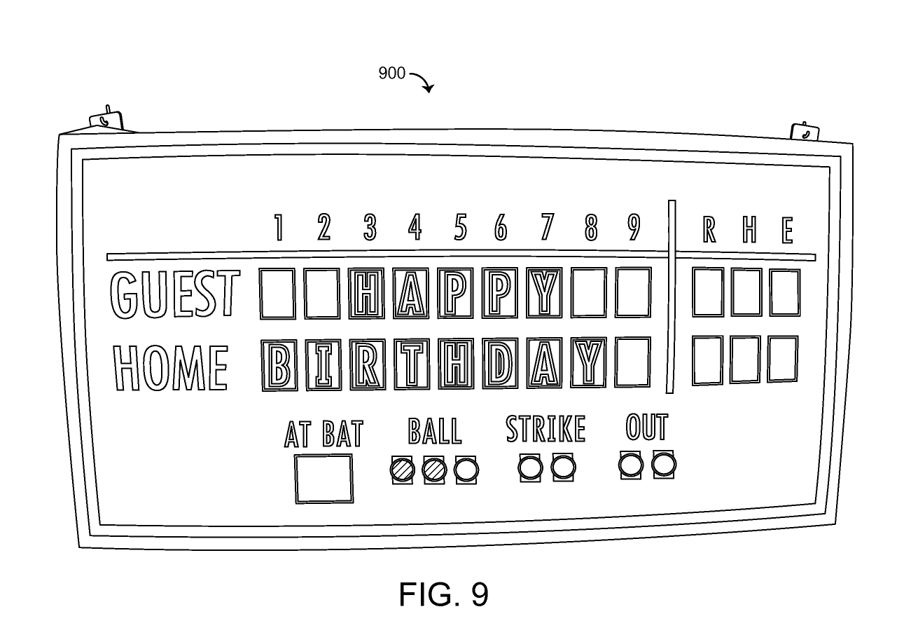

Referring generally to FIGS. 9-11, other possible configurations of wall artwork are illustrated. For example, the methods described herein may be used to form a substantially rectangular wall artwork. As shown in FIG. 9, a scoreboard 900 may be formed. The scoreboard 900 is shown as a substantially three-dimensional rectangular wall artwork. The collapsible protruding member may include a connector piece and a plurality of foldable creases (e.g., five) to form the four edges of the scoreboard and the front. In some embodiments, additional elements on the scoreboard 900 may be three-dimensional and/or collapsible in nature, such as letters and numbers on the scoreboard, portions indicating balls and strikes, etc. In some embodiments, some of these elements may be removable from the scoreboard 900.

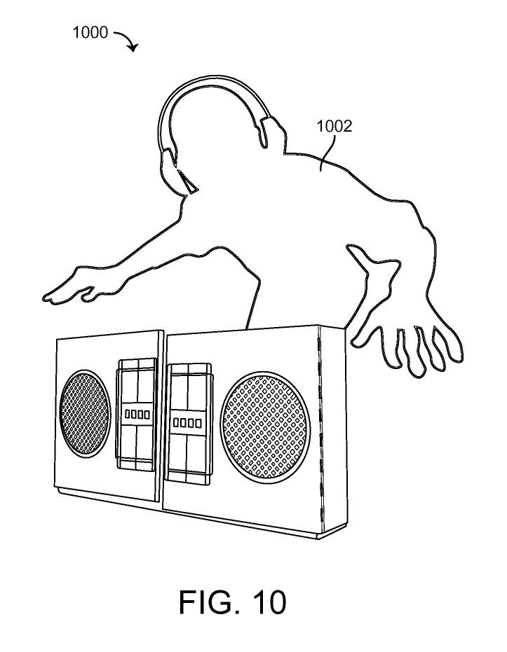

As shown in FIG. 10, a boombox 1000 may be formed using the methods described herein. The boombox 1000 is shown as a substantially three-dimensional rectangular wall artwork. The boombox 1000 includes two separate rectangular portions that may be formed and mounted on the wall separately. The wall artwork further includes a base portion 1002 that accompanies the design of the boombox 1000. In various embodiments, the design of the base portion may vary as to fit or not fit with the design of the collapsible protruding member.

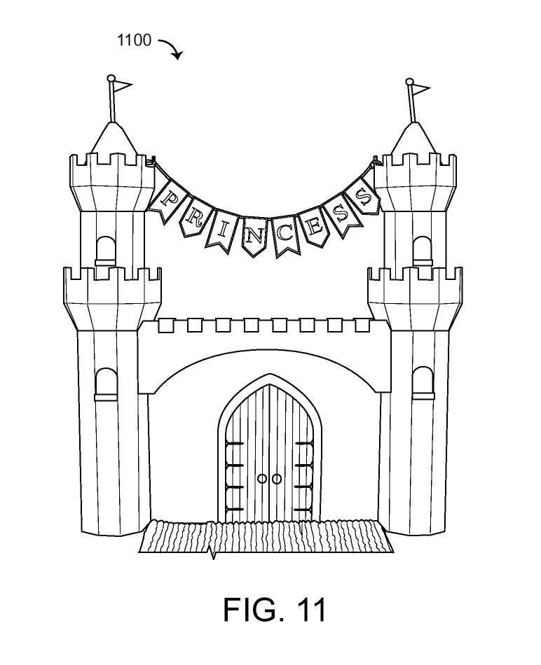

As shown in FIG. 11, a castle 1100 may be formed using the methods described herein. Castle 1100 is shown to include many portions that may be coupled together to form the three-dimensional shape of the castle. The various portions may be coupled to one or more of the base piece, connector piece, and other pieces. In some embodiments, the castle 1100 may be configured to be hung against a wall. In some embodiments, the castle 1100 may be on the grounds against the wall. In some such embodiments, a portion of the castle 1100 may be adhered or otherwise coupled to the wall to keep it from tipping forward.

The tabs may be adjusted in various ways. For example, the tabs may be configured to be folded, twisted, bent, or otherwise adjusted in order to fit the tabs through each slot and to secure the tabs after insertion such that the tabs do not slip out of the slot.

In one embodiment, the tabs and slots of the wall artwork may be positioned on the various portions to control the size of the wall artwork. For example, the tabs and slots may be located on the edges of each piece, maximizing the size of the wall artwork, or may be located in an inner location of each piece, minimizing the size of the wall artwork.

In one embodiment, the wall artwork assembly may additionally include fasteners to secure the location of one or more portions, or to secure one or more tabs. The wall artwork may include any other type of object for securing the position of any element.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. Furthermore, no element, component or method step in the present disclosure is intended to be dedicated to the public, regardless of whether the element, component or method step is explicitly recited in the claims.

The construction and arrangement of the collapsible three-dimensional wall artwork as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

It should be noted that although the flowcharts provided herein show a specific order of method steps, it is understood that the order of these steps may differ from what is depicted. Also two or more steps may be performed concurrently or with partial concurrence. It is understood that all such variations are within the scope of the disclosure.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A collapsible three-dimensional wall artwork comprising:
a collapsible protruding member comprising at least one folding portion, the collapsible protruding member further comprising a connecting portion configured to couple the collapsible protruding member to a wall;
wherein the at least one folding portion is configured to be folded to form a three-dimensional structure extending outward from the wall in an assembled configuration.

2. The artwork of claim 1, wherein, in a disassembled configuration, the collapsible protruding member comprises one or more substantially flat pieces.

3. The artwork of claim 1, wherein the at least one folding portion comprises a plurality of pieces configured to be coupled together in the assembled configuration to form the three-dimensional structure extending outward from the wall.

4. The artwork of claim 3, wherein the plurality of pieces are configured to be coupled together by inserting a plurality of tabs of the plurality of pieces into a plurality of slots of the plurality of pieces.

5. The artwork of claim 1, wherein the connecting portion comprises one or more slots configured to couple the collapsible protruding member to the wall through one or more connectors configured to extend through the one or more slots, wherein the one or more connectors are at least one of mounted to the wall or coupled to a base member attached to the wall.

6. The artwork of claim 1, further comprising a base member comprising a substantially flat portion configured to be coupled to the wall.

7. The artwork of claim 1, wherein the collapsible protruding member is configured to form a portion of a vehicle when in the assembled configuration.

8. The artwork of claim 1, wherein the collapsible protruding member is formed of cardboard.

9. A kit for forming a three-dimensional wall artwork, the kit comprising:
one or more pieces having a substantially flat state in a disassembled configuration, wherein the one or more pieces comprise a connecting portion configured to couple of the one or more pieces to a wall;
wherein the one or more pieces are configured to be attached in an assembled configuration to form a three-dimensional structure extending outward from the wall.

10. The kit of claim 9, wherein at least one of the one or more pieces comprises a folding portion configured to fold to form at least a portion of the three-dimensional structure extending outward from the wall in the assembled configuration, wherein the folding portion comprises a first connecting portion and a second connecting portion, and wherein the first connecting portion and the second connecting portion are configured to be coupled to one another in the assembled configuration.

11. The kit of claim 9, wherein the one or more pieces comprise a plurality of pieces configured to be coupled together in the assembled configuration to form the three-dimensional structure extending outward from the wall.

12. The kit of claim 11, wherein the plurality of pieces are configured to be coupled together by inserting a plurality of tabs of the plurality of pieces into a plurality of slots of the plurality of pieces.

13. The kit of claim 9, wherein the connecting portion comprises one or more slots configured to couple the one or more pieces to the wall through one or more connectors configured to extend through the one or more slots, wherein the one or more connectors are at least one of mounted to the wall or coupled to a base member attached to the wall.

14. The kit of claim 9, further comprising a base member comprising a substantially flat portion configured to be coupled to the wall.

15. The kit of claim 9, wherein the one or more pieces are configured to form a portion of a vehicle when in the assembled configuration.

16. The kit of claim 9, wherein the one or more pieces are formed of cardboard.

17. A method of producing a collapsible three-dimensional wall artwork, the method comprising:
forming a collapsible protruding member;
forming a plurality of foldable creases in the collapsible protruding member;
forming a plurality of folding connection portions in the collapsible protruding member; and
forming a wall connection portion in the collapsible protruding member;
wherein the collapsible protruding member is configured to be folded at the foldable creases and the plurality of folding connection portions are configured to be connected to one another such that the collapsible protruding member forms a three-dimensional structure extending outward from a wall in an assembled configuration; and
wherein the wall connection portion is configured to couple the collapsible protruding member to the wall.

18. The method of claim 17, further comprising forming a base member comprising a substantially flat portion configured to be coupled to the wall.

19. The method of claim 17, wherein the collapsible protruding member is formed from cardboard.
